(19) United States
(12) Patent Application Publication
(10) Pub. No.: US 2023/0178037 A1
(43) Pub. Date: Jun. 8, 2023

(54) CONTROL METHOD FOR BACKLIGHT UNIT, DISPLAY PANEL, AND DISPLAY DEVICE

(71) Applicant: TCL China Star Optoelectronics Technology Co., Ltd., Shenzhen, Guangdong (CN)

(72) Inventor: Xiaolong CHEN, Shenzhen, Guangdong (CN)

(73) Assignee: TCL China Star Optoelectronics Technology Co., Ltd., Shenzhen, Guangdong (CN)

(21) Appl. No.: 17/429,728

(22) PCT Filed: May 31, 2021
(86) PCT No.: PCT/CN2021/097123

§ 371 Date: Aug. 10, 2021

(30) Foreign Application Priority Data
Jan. 8, 2021 (CN) 202110023236.7

(51) Int. Cl. G09G 3/34

(52) U.S. Cl. CPC G09G 3/3406; G09G 2320/041; G09G 2320/0233

(57) ABSTRACT

A control method for a backlight unit, a display panel, and a display device are disclosed. The control method includes obtaining ambient temperature through a temperature detection module; comparing the ambient temperature with a first standardized temperature reference value; and determining a driving mode of a light-emitting unit included in the backlight unit based on a comparison result. When the ambient temperature is higher than or equal to the first standardized temperature reference value, a driving method includes first driving subfields, and each of the first driving subfields consists of a bright subfield and a dark subfield.

### BACKGROUND OF INVENTION

### 1. Field of Invention

The present application relates to a technical field of displays, and more particularly, to a control method for a backlight unit, a display panel, and a display device.

### 2. Related Art

With digitalization of society, there are increasing demands for effectiveness, readiness, and quality of information display technologies. Display industry technologies have been developed and gradually become mature since the 1990s. Because of their advantages of high definition, decent color performance, power savings, compactness, and easy to carry, flat panel displays have been widely used in information display products and therefore have a promising prospect in markets. With the increasing maturity of driving technologies in the display industries, there come more opportunities and challenges. Due to limitations of backlights of liquid crystal displays (LCDs), such as large power consumption, low contrast ratio, and other shortcomings, research of the backlights has turned to local dimming technologies.

Current mini light-emitting diodes (mini-LEDs for short) adopt static driving approaches or passive matrix (PM) solutions to achieve local dimming of the backlight. Since each partitioned area needs to be controlled by a data line separately, number of partitions is generally less than 2000 partitions and too many driver chips are required, thereby resulting in high product cost. Therefore, the only way to reach popularity of actual mass-produced products in the market is to find a technical solution to reduce costs. As a result, an active matrix (AM) based mini-LED backlight unit driving method has become an effective way to reduce a number of LED driver chips to serve the purpose of cost reduction.

At present, the AM mini-LED backlights use constant voltage to drive LED light boards, and the LED light boards will heat up after being turned on, causing a temperature to rise. FIG. 1A shows a relationship between an ambient temperature T and a forward turning-on voltage V_{f} in the LED light board. The horizontal coordinate represents the ambient temperature T, and the vertical coordinate represents the forward turning-on voltage V_{f}. As can be seen from FIG. 1A, when the ambient temperature is Tₐ, the forward turning-on voltage of the LED light board is V_{fa}; and when the ambient temperature is T_{b} (T_{b}>Tₐ), the forward turning-on voltage of the LED light board is V_{fb} (V_{fb}<V_{fa}). As can be seen from FIG. 1A, when the ambient temperature T rises, the number of electron-hole pairs increases with rising of the ambient temperature T, and thus the required electric field decreases, resulting in a decrease in the forward turning-on voltage V_{f}. FIG. 1B shows a relationship curve between the ambient temperature T, driving current I, and the forward turning-on voltage V_{f} in the LED light board, in which the horizontal coordinate represents the driving current I, and the vertical coordinate represents the forward turning-on voltage V_{f}. It can be seen from FIG. 1B that under the same forward turning-on voltage, the driving current is I1 when the ambient temperature is Ta, and the driving current is I2 (I₁<I₂) when the ambient temperature is T_{b} (T_{b}>Tₐ). It can be seen from FIG. 1B that the high temperature causes the driving current I of the LED light board to increase in the constant voltage state.

FIG. 1C shows a table of the values of brightness and power of television (TV) products of AM mini-LEDs under different ambient temperatures. As can be seen from FIG. 1C, when the ambient temperature is in the range of (0□-40□), the brightness of the LED light board increases with rising of the ambient temperature T, and meanwhile the power P of the LED light board also keeps increasing. When the ambient temperature is in the range of (40□-50□), as the ambient temperature T increases, the brightness of the LED light board reaches thermal equilibrium and then tends to stabilize, and meanwhile the power P of the LED light board also keeps increasing. As the voltage remains unchanged due to the constant voltage drive mode of the LED light board, an increase in the driving current I of the LED light board means that the power consumption increases, along with rising temperature, and so on until thermal equilibrium. Furthermore, the brightness of the LED light board will increase with the increase in current, which means that the brightness of LED lights will rise with the increase in the light-on time of the LED light board until thermal equilibrium, and then the brightness of the LED light board is stable. In this manner, the power of AM mini-LED TV products also increases with the change of the brightness, resulting in power overload problems. To summarize, AM mini-LED TV products in higher ambient temperature will have power overload problems, and the brightness will shift with the increase in ambient temperature.

Therefore, there is a need for providing a backlight unit control method, a display panel, and a display device to overcome the above-mentioned defects.

### SUMMARY OF INVENTION

The present application is provided to overcome a technical problem that current active matrix mini light-emitting diode (AM mini-LED) TV products encounter the problem of power overload when the ambient temperature is high, and the brightness will be shifted with the increase in the ambient temperature.

To overcome the above-mentioned problem, an embodiment of the present application is to provide a control method for a backlight unit, wherein the control method comprises following steps:

S10: obtaining ambient temperature through a temperature detection module;
S20: comparing the ambient temperature with a first standardized temperature reference value; and
S30: determining a driving mode of light-emitting units included in the backlight unit based on a comparison result.

When the ambient temperature is higher than or equal to the first standardized temperature reference value, the driving mode is determined as a first backlight driving mode, and the first backlight driving mode comprises first driving subfields, each of the first driving subfields consists of a bright subfield and a dark subfield.

In the control method for the backlight unit provided by one embodiment of the present application, when the ambient temperature is less than the first standardized temperature reference value, the driving mode is an initial backlight driving mode with constant-voltage driving, wherein the initial backlight driving mode comprises initial driving subfields respectively corresponding to the first driving subfields, each of the initial driving subfields consists of a bright subfield or a dark subfield, and a sum of a duration of the bright subfield and a duration of the dark subfield of each of the first driving subfields is equal to that of a corresponding one of the initial driving subfields.

In the control method for the backlight unit provided by one embodiment of the present application, the control method further comprises following steps between the steps S10 and S30:

S21: comparing the ambient temperature with a second standardized temperature reference value, wherein the second standardized temperature reference value is greater than the first standardized temperature reference value.

When the ambient temperature is higher than or equal to the first standardized temperature reference value and less than the second standardized temperature reference value, the driving mode is the first backlight driving mode; and when the ambient temperature is higher than or equal to the second standardized temperature reference value, the driving mode is a second backlight driving mode.

First driving subfields of the second backlight driving mode corresponds to the first driving subfields of the first backlight driving mode, and a time ratio of the bright subfield to the first driving subfields of the second backlight driving mode is less than a time ratio of the bright subfield to the first driving subfields of the first backlight driving mode.

In the control method for the backlight unit provided by one embodiment of the present application, the control method further comprises following steps between the steps S10 and S30:

S21: comparing the ambient temperature with an (n+1)-th standardized temperature reference value, wherein the (n+1)-th standardized temperature reference value is greater than an n-th standardized temperature reference value;

When the ambient temperature is higher than or equal to the n-th standardized temperature reference value and less than the (n+1)-th standardized temperature reference value, the driving mode is an n-th backlight driving mode, and a time ratio of the bright subfield of the n-th backlight driving mode to the first driving subfields is less than a time ratio of the bright subfield of an (n−1)-th backlight driving mode D(n−1) to the first driving subfields, wherein n is a positive integer greater than 2.

In the control method for the backlight unit provided by one embodiment of the present application, a step of obtaining the duration of the bright subfield and the duration of the dark subfield within the first driving subfield in the first backlight driving mode or the second backlight driving mode comprises:

S201: driving the light-emitting units of the backlight unit according to a backlight driving mode of a previous level, wherein a maximum temperature in a temperature range corresponding to the backlight driving mode of the previous level is less than the ambient temperature;

S202: detecting whether a luminance value of the backlight unit is greater than that of the backlight unit driven in the backlight driving mode of the previous level in the corresponding temperature range; and

S203: adjusting the duration of the bright subfield or the duration of the dark subfield within the first driving subfields in the first backlight driving mode or the second backlight driving mode according to a detection result, so that the luminance value of the backlight unit is consistent with that of the backlight unit driven in the corresponding temperature range by the backlight driving mode of the previous level.

In the control method for the backlight unit provided by one embodiment of the present application, the step S203 further comprises:

S2031: if the luminance value when the backlight unit displays 2^{N-1} grayscales is greater than an initial luminance value of the backlight unit driven in the backlight driving mode of the previous level in the corresponding temperature range, increase the duration of the dark subfield of an N-th first driving subfield until the backlight unit displays a luminance value at 2^{N-1} grayscale equal to the initial luminance value; wherein if the luminance value of the backlight unit displaying 2^{N-1} grayscales is less than the initial luminance value, decrease the duration of the dark subfield of the N-th first driving subfield until the luminance value of the backlight unit displaying 2^{N-1} grayscales is equal to the initial luminance value, wherein N is a positive integer greater than or equal to 1.

In some embodiments, the first backlight driving mode is constructed by outputting the first driving subfields each having different durations in a predetermined order, and the first driving subfields are made by dividing a light-emitting process of a frame of each of the light-emitting units in the backlight unit through a dividing step, wherein the dividing step further comprises:

dividing the light-emitting process of the frame of each of the light-emitting units in the backlight unit into M number of the first driving subfields of the first driving subfields each having different durations, wherein a ratio of a duration of an i-th first driving subfield to a sum of durations of the M number of the first driving subfields is 2^{(i-1)-th}/2^{M}, the i-th first driving subfield corresponds to an (i−1)-th bit data, wherein i is an integer greater than or equal to 1 and less than or equal to M, and M is an integer greater than or equal to 2.

In the control method for the backlight unit provided by one embodiment of the present application, each of the light-emitting units of the backlight unit is a sub-millimeter light-emitting diode.

In a control method for a backlight unit provided by one embodiment of the present application, the control method comprises following steps:

S10: obtaining ambient temperature through a temperature detection module;

S20: comparing the ambient temperature with a first standardized temperature reference value; and

S30: determining a driving mode of light-emitting units included in the backlight unit based on a comparison result.

When the ambient temperature is higher than or equal to the first standardized temperature reference value, the driving mode is determined as a first backlight driving mode, and the first backlight driving mode comprises first driving subfields, each of the first driving subfields consists of a bright subfield and a dark subfield.

A data voltage applied during a duration of the bright subfield is high potential, and a data voltage applied during a duration of the dark subfield is low potential.

In the control method for the backlight unit provided by one embodiment of the present application, when the ambient temperature is less than the first standardized temperature reference value, the driving mode is an initial backlight driving mode with constant-voltage driving, wherein the initial backlight driving mode comprises initial driving subfields respectively corresponding to the first driving subfields, each of the initial driving subfields consists of a bright subfield or a dark subfield, and a sum of a duration of the bright subfield and a duration of the dark subfield of each of the first driving subfields is equal to that of a corresponding one of the initial driving subfields.

In the control method for the backlight unit provided by one embodiment of the present application, the control method further comprises following steps between the steps S10 and S30:

S21: comparing the ambient temperature with a second standardized temperature reference value, wherein the second standardized temperature reference value is greater than the first standardized temperature reference value.

When the ambient temperature is higher than or equal to the first standardized temperature reference value and less than the second standardized temperature reference value, the driving mode is the first backlight driving mode; and when the ambient temperature is higher than or equal to the second standardized temperature reference value, the driving mode is the second backlight driving mode.

First driving subfields of the second backlight driving mode correspond to the first driving subfields of the first backlight driving mode, and a time ratio of the bright subfield to the first driving subfield of the second backlight driving mode is less than a time ratio of the bright subfield to the first driving subfields of the first backlight driving mode.

In the control method for the backlight unit provided by one embodiment of the present application, the control method further comprises following steps between the steps S10 and S30:

S21: comparing the ambient temperature with an (n+1)-th standardized temperature reference value, wherein the (n+1)-th standardized temperature reference value is greater than the n-th standardized temperature reference value.

When the ambient temperature is higher than or equal to the n-th standardized temperature reference value and less than the (n+1)-th standardized temperature reference value, the driving mode is an n-th backlight driving mode, and a time ratio of the bright subfield of the n-th backlight driving mode to the first driving subfields is less than a time ratio of the bright subfield of an (n−1)-th backlight driving mode D(n−1) to the first driving subfields, wherein n is a positive integer greater than 2.

In the control method for the backlight unit provided by one embodiment of the present application, a step of obtaining the duration of the bright subfield and the duration of the dark subfield within the first driving subfield in the first backlight driving mode or the second backlight driving mode comprises:

S201: driving the light-emitting units of the backlight unit according to the driving mode of a previous level, wherein a maximum temperature in a temperature range corresponding to the driving mode of the previous level is less than the ambient temperature;

S202: detecting whether a luminance value of the backlight unit is greater than that of the backlight unit driven in the backlight driving mode of the previous level in the corresponding temperature range; and

S203: adjusting the duration of the bright subfield or the duration of the dark subfield within the first driving subfields in the first backlight driving mode or the second backlight driving mode according to a detection result, so that the luminance value of the backlight unit is consistent with that of the backlight unit driven in the backlight driving mode of the previous level in the corresponding temperature range.

In the control method for the backlight unit provided by one embodiment of the present application, the step S203 further comprises:

S2031: if the luminance value when the backlight unit displays 2^{N-1} grayscales is greater than an initial luminance value of the backlight unit driven in the backlight driving mode of the previous level in the corresponding temperature range, increase the duration of the dark subfield of an N-th first driving subfield until the backlight unit displays a luminance value at 2^{N-1} grayscale equal to the initial luminance value; wherein if the luminance value of the backlight unit displaying 2^{N-1} grayscales is less than the initial luminance value, decrease the duration of the dark subfield of the N-th first driving subfield until the luminance value of the backlight unit displaying 2^{N-1} grayscales is equal to the initial luminance value, wherein N is a positive integer greater than or equal to 1.

In the control method for the backlight unit provided by one embodiment of the present application, the first backlight driving mode is constructed by outputting the first driving subfields each having different durations in a predetermined order, and the first driving subfields are made by dividing a light-emitting process of a frame of each of the light-emitting units in the backlight unit through a dividing step, wherein the dividing step further comprises:

dividing the light-emitting process of the frame of each of the light-emitting units in the backlight unit into M number of the first driving subfields of the first driving subfields each having different durations, wherein a ratio of a duration of an i-th first driving subfield to a sum of durations of the M number of the first driving subfields is 2^{(i-1)-th}/2^{M}, the i-th first driving subfield corresponds to an (i−1)-th bit data, wherein i is an integer greater than or equal to 1 and less than or equal to M, and M is an integer greater than or equal to 2.

In the control method for the backlight unit provided by one embodiment of the present application, each of the light-emitting units of the backlight unit is a sub-millimeter light-emitting diode.

An embodiment of the present application further provides a display panel that comprises a temperature detection module, a memory for storing commands, a controller for executing the commands to implement any of the above-mentioned control methods, and a backlight unit.

In the display panel provided by one embodiment of the present application, the memory comprises any one of a read-only memory, random access memory, disk, or optical disk.

In the display panel provided by one embodiment of the present invention, the backlight unit has a plurality of partitions, each of the partitions is provided with a light-emitting unit, and the light-emitting unit is a sub-millimeter light-emitting diode.

An embodiment of the present invention further provides a display device that comprises the above-mentioned display panel.

The present application has advantageous effects as follows: compared with related art techniques, the backlight unit control method, the display panel, and the display device provided in the embodiments of the present application control the brightness emitted by the lighting units of the backlight unit based on non-uniformly divided subfields, and adjust the durations of each driving subfield of the backlight unit in the light subfield and the dark subfield under different ambient temperature, thus providing uniform brightness performance under different ambient temperatures and thereby achieving the goal of improving the stability of the display device under different ambient temperatures. This further makes the backlight brightness of the display device not shift with the increase of the ambient temperature, thereby preventing the problem that the power of the display device exceeds the regulations.

### BRIEF DESCRIPTION OF DRAWINGS

FIG. 1A is a diagram illustrating a relationship curve between ambient temperature T and a forward turning-on voltage V_{f} in a light-emitting diode (LED) light board.

FIG. 1B is a diagram illustrating a relationship curve between the ambient temperature T, driving current I, and the forward turning-on voltage V_{f} in the LED light board.

FIG. 1C shows a table of values of brightness and power of an active matrix (AM) mini-LED TV product under different ambient temperatures.

FIG. 2 is a flowchart illustrating a control method for a backlight unit provided by an embodiment of the present application.

FIG. 3 is a diagram illustrating different backlight driving modes corresponding to different ambient temperature ranges of a display device provided by an embodiment of the present application.

FIG. 4A is a diagram illustrating a gate waveform controlled by non-even subfields of an initial backlight driving mode D0 adopted in an embodiment of the present application.

FIG. 4B is a diagram illustrating the gate waveform controlled by non-even subfields of different backlight driving modes adopted in an embodiment of the present application.

FIG. 5A is a flowchart illustrating a method of calculating durations of bright subfields and dark subfields in each first driving subfield provided by an embodiment of the present application.

FIG. 5B is a flowchart illustrating a method of calculating the durations of the bright subfields and dark subfields in each first driving subfield according to a first backlight driving mode D1 provided in an embodiment of the present application.

FIG. 6 is a diagram illustrating waveforms of a gate voltage side and a data voltage side of the first backlight driving mode D1 provided in an embodiment of the present application when displaying a grayscale B=(0001101) B.

FIG. 7 is a block diagram of a structure of a pixel compensation device of the display device of the present application.

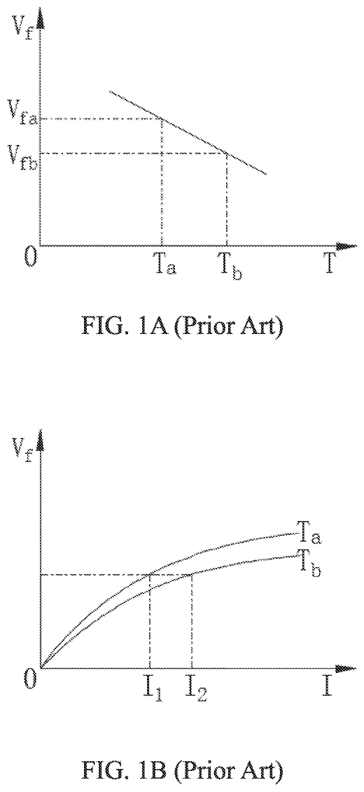

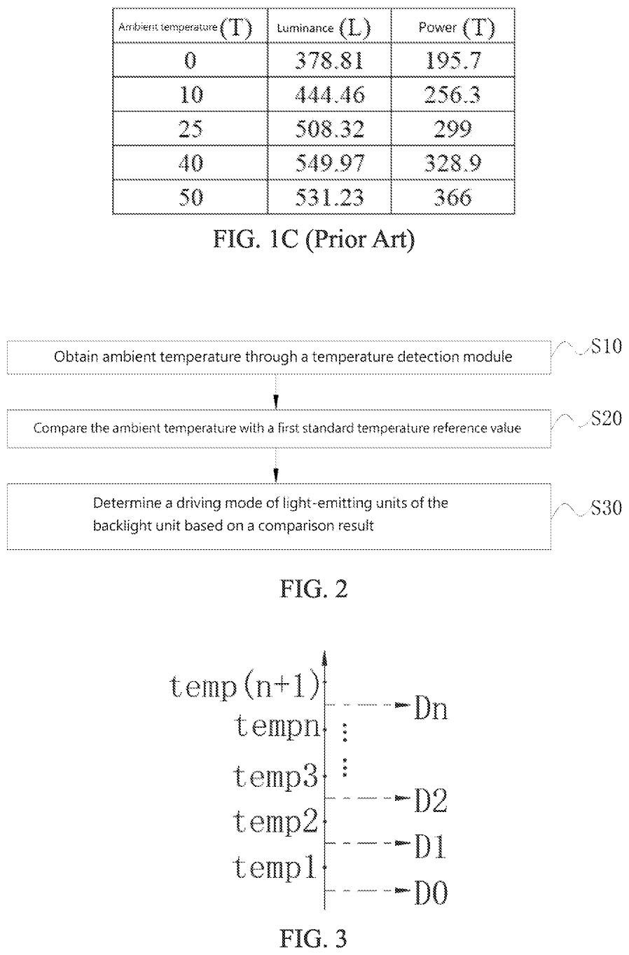

### DESCRIPTION OF PREFERRED EMBODIMENTS

Embodiments in the present application address the technical problem encountered in current technologies that brightness of light-emitting units of backlight units shift as ambient temperature rises, further causing the power of display devices to exceed the limit, and the embodiments in the present application can solve the defect.

Refer to FIG. 2, which is a flowchart illustrating a control method for a backlight unit according to an embodiment of the present application. The control method for the backlight unit is applied to a display panel, the display panel includes a backlight light board, and the control method includes following steps:

S10: obtaining ambient temperature T through a temperature detection module;

Specifically, step S10 further includes following details.

First, a temperature detection module is added to the whole of the display panel, and ambient temperature T is obtained through the temperature detection module, in which light-emitting units of the backlight unit are preferably implemented with mini-light-emitting diodes (LEDs).

S20: comparing the ambient temperature with a first standardized temperature reference value temp1.

Specifically, step S20 further includes following details.

When the ambient temperature T is less than the first standardized temperature reference value temp1 (T<temp1), a driving mode is a constant voltage driven initial backlight driving mode D0. The initial backlight driving mode D0 includes initial driving subfields, and each initial driving subfield consists of a bright subfield or a dark subfield.

Specifically, a data voltage during a duration of the bright subfield is in high potential, and data voltage during the dark subfield period is in low potential.

When the ambient temperature T is higher than or equal to the first standardized temperature reference value temp1 and less than the second standardized temperature reference value temp2 (temp1≤T≤temp2), the light-emitting units of the backlight unit are driven in a first backlight driving mode D1. The first backlight driving mode D1 includes first driving subfields corresponding to the initial driving subfields, respectively, and each of the first driving subfields consists of a bright subfield and a dark subfield. A sum of the duration of the bright subfield and the duration of the dark subfield of each first driving subfield is equal to the duration of the corresponding one of the initial driving subfields.

When the ambient temperature T is higher than or equal to the second standardized temperature reference value temp 2 and less than the third standardized temperature reference value temp 3, the driving mode is a second backlight driving mode D2. First driving subfields of the second backlight driving mode D2 correspond to the first driving subfields of the first backlight driving mode D1, respectively. A time ratio of the bright subfield of the second backlight driving mode D2 to the first driving subfield of the second backlight driving mode D2 is less than a time ratio of the bright subfield of the first backlight driving mode D1 to the first driving subfield of the first backlight driving mode D1.

Preferably, when the ambient temperature T is higher than or equal to an n-th standardized temperature reference value tempn and less than an (n+1)-th standardized temperature reference value temp (n+1) (tempn≤T≤temp(n+1)), the driving mode is the n-th backlight driving mode Dn. The first driving subfields of the n-th backlight driving mode Dn correspond to the first driving subfields of the first backlight driving mode D1, respectively. A time ratio of the bright subfield of the n-th backlight driving mode Dn to the first driving subfield is less than a time ratio of the bright subfield of the (n−1)-th backlight driving mode D(n−1) to the first driving subfield, wherein n is a positive integer greater than 2.

FIG. 3 shows step S30 as follows:

S30: the driving mode of the light-emitting units of the backlight unit is determined based on a comparison result.

Specifically, step S30 further includes:

When the ambient temperature T is less than the first standardized temperature reference value temp1 (T<temp1), the driving mode is the constant voltage driven initial backlight driving mode D0, and the initial backlight driving mode D0 is used to drive the backlight unit in the driving process as described below.

The backlight unit has a plurality of partitions, and each partition is provided with light-emitting units. The backlight data of each partition is first obtained from a time controller (Tcon) or a field programmable gate array (FPGA). The backlight data of each partition is obtained by algorithmic processing based on the data information of the image to be displayed. The backlight data includes data from the bit 0 to the bit M−1, and the data from the bit 0 to the bit M−1 can be 0 or 1, wherein the bit 0 is the lowest bit and the bit M−1 is the highest bit.

Each backlight unit can emit light of different brightness. For example, when the grayscale level of the backlight unit is 7 bits, the backlight unit can emit light of 128 different brightness, i.e., the brightness corresponding to grayscales 0-127. When the grayscale level of the backlight unit is 8, the backlight unit can emit light of 256 different brightness. When the grayscale level of the backlight unit is 10, the backlight unit can emit light of 1024 different brightness.

One backlight unit as mentioned above may consist of a single backlight module, or be constructed by stitching together a plurality of independently controlled backlight modules. Each backlight unit has a plurality of partitions. Each partition is provided with the same number of inorganic light-emitting diodes in series, preferably mini-LEDs. The inorganic light-emitting diodes include red inorganic light-emitting diodes, blue inorganic light-emitting diodes, and green inorganic light-emitting diodes. The inorganic light-emitting diodes may also include white inorganic light-emitting diodes.

Each backlight unit also includes a plurality of parallel scan lines and a plurality of parallel data lines. The scan lines are insulated from the data lines, and the scan lines and the data lines are arranged to intersect with each other. Each light-emitting unit is connected to one scan line and one data line, the same column of light-emitting units are connected to the same scan line, and the same row of light-emitting units are connected to the same data line.

Further, the light-emitting process of each partitioned light-emitting unit in a frame is divided into a plurality of initial driving subfields with different durations, and each initial driving subfield corresponds to one-bit data.

Specifically, the light-emitting process of the frame of each of the light-emitting units in the backlight unit is divided into M first driving subfields of the first driving subfields each having different durations, and the time ratio of the duration of the i-th initial driving subfield to the sum of the durations of the M initial driving subfields is 2⁽ⁱ⁻¹⁾/2^{M}. The i-th initial driving subfield corresponds to the (i−1)-th bit data, wherein i is an integer greater than or equal to 1 and less than or equal to M, and M is an integer greater than or equal to 2. The duration of the i-th initial driving subfield is equal to 2⁽ⁱ⁻¹⁾t/2^{M}, and t is the duration of one frame.

Number of the initial driving subfields for each partitioned light-emitting unit in a frame duration depends on the grayscale level of the backlight unit, and the number of the initial driving subfields is 7 if the grayscale level of the backlight unit is 7, or otherwise, the number of the initial driving subfields is 8 if the grayscale level of the backlight unit 20 is 8. The duration of the M initial driving subfields are different from each other, and each initial driving subfield corresponds to one-bit data. The different bit durations represent the contribution of different bits to the backlight luminance, i.e., representing the weightings of different bits. The longer the duration of each initial driving subfield is, the larger the weighting is.

Finally, a plurality of the initial driving subfields respectively corresponding to partition with different durations are outputted in a predetermined order. Specifically, the first initial driving subfield to the M-th initial driving subfield are sequentially outputted. In addition, in the i-th initial driving subfield, the light-emitting unit inputs the data of the (i−1)-th bit data corresponding to the i-th initial driving subfield and outputs the i-th initial driving subfield, wherein the multi-bit data is 0 or 1. When the (i−1)-th bit data is 1, the light-emitting unit is in a bright state in the duration corresponding to the i-th initial driving subfield (in this state, the data voltage “data” outputs a high potential). When the (i−1)-th bit data is 0, the light-emitting unit is in a dark state in the duration corresponding to the i-th initial driving subfield (in this state, the data voltage “data” outputs a low potential).

The initial backlight driving mode D0 is displayed by dividing the backlight data of each partition of the backlight unit into a plurality of initial driving subfields with different durations, wherein each initial driving subfield corresponds to one-bit data, so that the data of different bits contribute differently to the backlight brightness, i.e., data of different bits includes different weightings. This approach can use the cumulative effect of light in duration to enable multiple partitions of the backlight unit to emit a plurality of different brightness of light, which can reduce power consumption relative to conventional backlight units. This approach also make use of active control, which can reduce the amount of control signals, thereby achieving cost reduction.

The control method for the backlight unit using the initial backlight driving mode D0 is described in detail below in conjunction with specific examples, taking a 240 Hz, 7-bit grayscale backlight unit as an example.

For a partition in the backlight unit 20, the front-end timing controller TCON or FPGA provides 7-bit data B=(0001101)_{B}, where the 0-th bit B[0] is indicated by 1, the first bit B[1] is indicated by 0, the second bit B[2] is indicated by 1, the third bit B[3] is indicated by 1, the fourth bit B[4] is indicated by 0, the fifth bit B[5] is indicated by 0, and the sixth bit B[6] is indicated by 0.

The duration of each frame is 4.16 ms, which is further divided into 7 parts. The duration of the first initial driving subfield SF1 is 32.5 μs, corresponding to the value “1” of the 0-th bit B[0]. The duration of the second initial driving subfield SF2 65 μs, which is twice the duration of the first initial driving subfield SF1 and corresponding to the value “0” of the first bit B[1]. The duration of the third initial driving subfield SF3 is 130 μs, which is twice the duration of the second initial driving subfield SF2 and corresponding to the value “1” of the second bit B[2]. The duration of the fourth initial driving subfield SF4 is 260 μs, corresponding to the value “1” of the third bit B[3]. The duration of the fifth initial driving subfield SF5 is 520 μs, corresponding to the value “0” of the fifth bit B[5]. The duration of the sixth initial driving subfield SF6 is 1.04 ms, corresponding to corresponding to the value “0” of the sixth bit B[6]. The duration of the seventh initial driving subfield SF7 is 2.08 ms, corresponding to the value “0” of the seventh bit B[7].

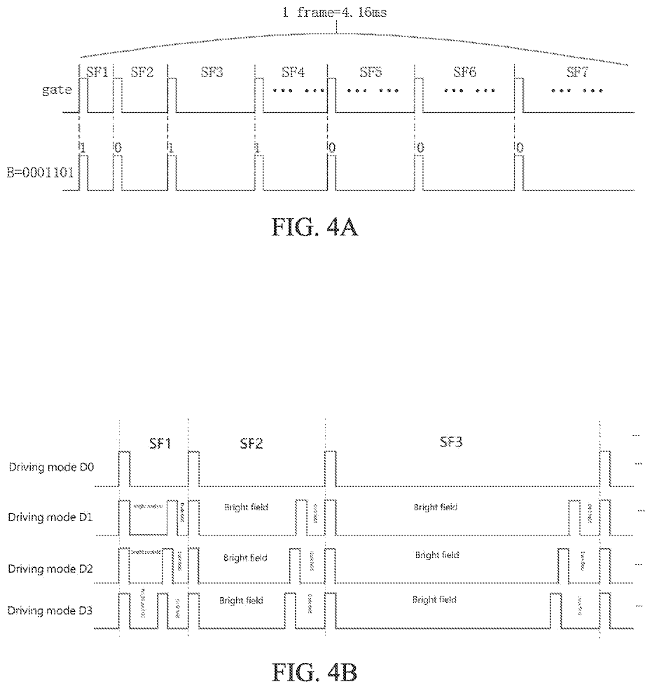

FIG. 4A is a diagram illustrating the gate waveform controlled by non-even subfields of the initial backlight driving mode D0 adopted in an embodiment of the present application. As shown in FIG. 4A, the backlight unit is in the bright state in the first initial driving subfield SF1, the third initial driving subfield SF3, and the fourth initial driving subfield SF4, wherein the data voltage outputs a high potential in the bright state, making the backlight current in these three sub-regions largest amongst all sub-regions. Meanwhile, the remaining four initial driving subfields are in the dark state, wherein the data voltage output a low potential in the dark state, making the backlight current in these four sub-regions smallest amongst all sub-regions.

In this manner, using the initial backlight driving mode D0 to drive the backlight unit can indicate the contribution of data with different bits to the backlight brightness by the displayed durations of different bits, i.e., indicating the weightings of different bits, thus achieving a partitioned brightness control.

Specifically, when the ambient temperature T is higher than or equal to the first standardized temperature reference value temp1 and less than the second standardized temperature reference value temp2 (temp1≤T≤temp2), the light-emitting units of the backlight unit are driven in a first backlight driving mode D1, wherein the first backlight driving mode D1 is outputted by a plurality of the first driving subfields having different time lengths according to a predetermined order. The first driving subfields are divided by each of the light-emitting units of the backlight unit in the process of the light emission of one frame using a dividing step, and the dividing step further includes:

dividing the light-emitting process of the frame of each of the light-emitting units in the backlight unit into M first driving subfields of the first driving subfields each having different durations, a ratio of the duration of an i-th first driving subfield to the sum of the durations of the M first driving subfields is 2⁽ⁱ⁻¹⁾/2^{M}, the i-th first driving subfield corresponds to an (i−1)-th bit data, i is an integer greater than or equal to 1 and less than or equal to M, and M is an integer greater than or equal to 2.

The driving process for driving the backlight unit using the first backlight driving mode D1 is similar to the driving process for driving the backlight light board using the initial backlight driving mode D0, which is described as follows.

First, the backlight data of each partition is obtained from Tcon or FPGA. Second, the light-emitting process of one frame of the light-emitting unit of each partition is divided into a plurality of first driving subfields with different duration, and each first driving subfield corresponds to one-bit data. Finally, the first driving subfields with different durations, which respectively corresponds to the partitions, are outputted in a predetermined order.

Note that the first driving subfield differs from the initial driving subfield only in that each first driving subfield includes a bright subfield and a dark subfield, wherein the sum of the duration of the bright subfield and the duration of the dark subfield to each first driving subfield is equal to the duration of the corresponding one of the initial driving subfields.

Specifically, the sum of the bright subfield duration T_{D1,1,bright} and the dark subfield duration T_{D1,1,dark} of the first driving subfield of the first backlight driving mode D1 is equal to the duration T_{D0,1} of the first one of first initial driving subfields in the initial backlight driving mode D0. The sum of the bright subfield duration T_{D1,2,bright} and the dark subfield duration T_{D1,2,dark} of the second one of first driving subfields in the first backlight driving mode D1 is equal to the duration T_{D0,2} of the second the initial driving subfield of the initial backlight driving mode D0.

Specifically, when the ambient temperature T is higher than or equal to the second standardized temperature reference value temp2 and less than the third standardized temperature reference value temp3 (temp2≤T≤temp3), the driving mode is a second backlight driving mode D2, wherein first driving subfields of the second backlight driving mode D2 correspond to the first driving subfields of the first backlight driving mode D1.

Note that the second backlight driving mode D2 differs from the first backlight driving mode D1 only in that the time ratio of the bright subfield of the second backlight driving mode D2 to the first driving subfield of the second backlight driving mode D2 is less than the time ratio of the bright subfield of the first backlight driving mode D1 to the first driving subfield.

Specifically, the sum of the bright subfield duration T_{D2,1,bright} and the dark subfield duration T_{D2,1,dark} of the first of the first driving subfields of the second backlight driving mode D2 is equal to the duration T_{D0,1} of the first initial driving subfield of the initial backlight driving mode D0.

Preferably, when the ambient temperature T is higher than or equal to the n-th standardized temperature reference value tempn and less than the (n+1)-th standardized temperature reference value temp(n+1) (tempn≤T<temp(n+1)), the driving mode is the n-th backlight driving mode Dn. The time ratio of the bright subfield of the n-th backlight driving mode Dn to the first driving subfield is less than the time ratio of the bright subfield of the (n−1)-th backlight driving mode D(n−1) to the first driving subfield, wherein n is a positive integer greater than 2.

In a preferred embodiment, when n=3, the sum of the bright subfield duration T_{D3,i,bright} and the dark subfield duration T_{D3,i,dark} of the i-th second type of drive subfield of the third backlight driving mode D3 is equal to the duration T_{D0,i} of the i-th initial driving subfield of the initial backlight driving mode D0, and the time ratio of the bright subfield of the third backlight driving mode D3 to the first driving subfield is less than the time ratio of the bright subfield of the second backlight driving mode D2 to the first driving subfield, as shown in FIG. 4B.

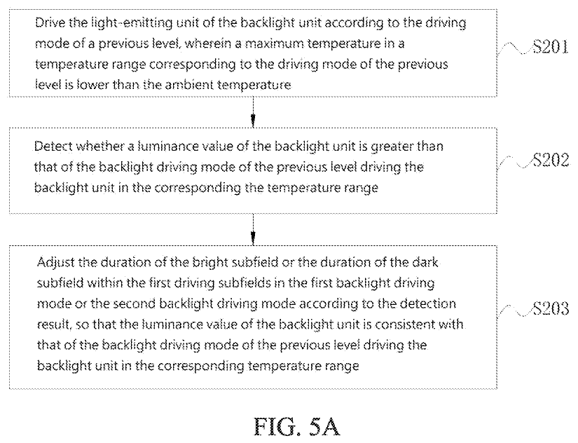

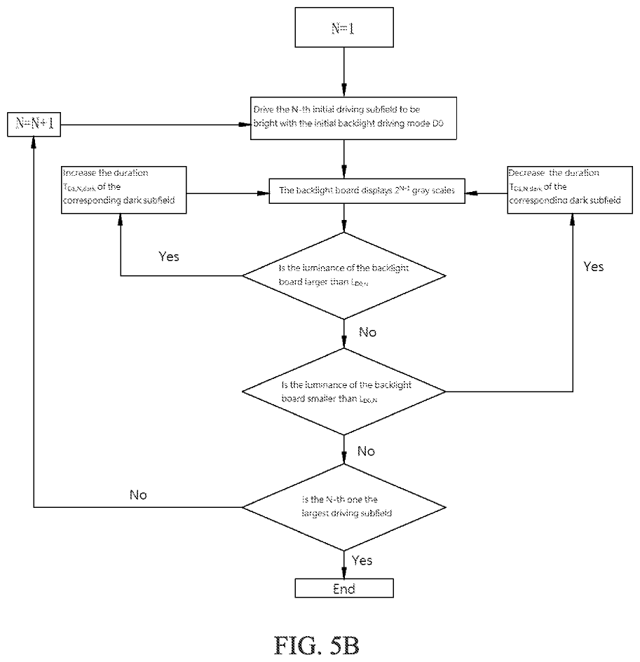

As shown in FIG. 5A, a method for obtaining the bright subfield duration and the dark subfield duration in the first driving subfields of the first backlight driving mode D1 or the second backlight driving mode D2 includes:

S201: driving the light-emitting units of the backlight unit according to the driving mode of a previous level, wherein a maximum temperature in a temperature range corresponding to the driving mode of the previous level is less than the ambient temperature T;

S202: detecting whether a luminance value of the backlight unit is greater than that of the backlight unit driven in the backlight driving mode of the previous level in the corresponding temperature range; and

S203: adjusting the duration of the bright subfield or the duration of the dark subfield within the first driving subfields in the first backlight driving mode D1 or the second backlight driving mode D2 according to a detection result, so that the luminance value of the backlight unit is consistent with that of the backlight unit driven in the corresponding temperature range by the backlight driving mode of the previous level;

wherein if the luminance value at 2^{N-1} grayscale displayed by the backlight unit is greater than an initial luminance value of the backlight unit driven in the backlight driving mode of the previous level in the corresponding temperature range, then increase the duration of the dark subfield in the first driving subfield until the backlight unit displays a luminance value at 2^{N-1} grayscale equal to the initial luminance value; and if the luminance value at 2^{N-1} grayscale displayed by the backlight unit is less than the initial luminance value, then reduce the duration of the dark subfield in the N-th first driving subfield until the backlight unit displays 2^{N-1} grayscale with luminance value equal to the initial luminance value, where N is a positive integer greater than or equal to 1.

The following is a detailed description of the method of determining the bright subfield duration and dark subfield duration for each of the first driving subfields in the first backlight driving mode D1, with specific embodiments provided. Similarly, the bright subfield duration and dark subfield duration to each of the first driving subfields in the second backlight driving mode D2 and the n-th backlight driving mode Dn (n is a positive integer greater than 2) can be determined using the same concept.

FIG. 5B is a flowchart illustrating a method of calculating the durations of the bright subfields and dark subfields in each first driving subfield according to the first backlight driving mode D1 provided in an embodiment of the present application, and detailed steps are as follows:

S201: driving the light-emitting units of the backlight unit according to the initial backlight driving mode D0, wherein the maximum temperature in the temperature range corresponding to the initial backlight driving mode D0 is less than the ambient temperature T. Afterwards, the N-th initial driving subfield is driven to be bright by the initial backlight driving mode D0, causing the backlight unit corresponding to the backlight light board to display 2^{N-1} grayscale, wherein N is a positive integer greater than or equal to 1, and N is the maximum number of the initial driving subfields corresponding to the initial backlight driving mode D0.

S202, detecting whether the luminance value L at this moment of the backlight unit is greater than the luminance value L_{D0,N} when the N-th initial driving subfield is driven to be bright by the initial backlight driving mode D0.

Specifically, in the embodiment of the backlight unit with 240 Hz and 7 bit grayscale, each frame is 4.16 ms and is divided into seven parts. As a result, the duration of the first initial driving subfield SF1 is 32.5 μs; the duration of the second initial driving subfield SF2 is 65 μs which is twice the duration of the first initial driving subfield SF1; the duration of the third initial driving subfield SF3 is 130 μs which is twice the duration of the second initial driving subfield SF2; the duration of the fourth initial driving subfield SF4 is 260 μs; the duration of the fifth initial driving subfield SF5 is 520 μs; the duration of the sixth initial driving subfield SF6 is 1.04 ms; and the duration of the seven-th initial driving subfield SF7 is 2.08 ms. Therefore, the duration of the N-th initial driving subfield can be utilized to calculate the luminance value L_{D0,N} corresponding to the N-th initial driving subfield being bright, wherein the luminance value L_{D0,N} corresponding to the N-th initial driving subfield is confirmed as a known number.

S203: according to the detection result, adjusting the duration T_{D1,N,bright} of the bright subfield or the duration T_{D1,N,dark} of the dark subfield in the first driving subfield when the N-th first driving subfield is bright, so that the luminance value L of the backlight unit is the same as the luminance value L_{D0,N} of the N-th initial driving subfield driven to be bright in the initial backlight driving mode D0.

Specifically, in one example, if L>L_{D0,N}, increasing the duration T_{D1,N,dark} of the dark subfield in the N-th first driving subfield in the first backlight driving mode D1 until the condition “L=L_{D0,N}” is reached.

Specifically, if L<LD0,N, the duration T_{D1,N,dark} of the dark subfield in the N-th first driving subfield in the first backlight driving mode D1 is reduced until the condition “L=L_{D0,N}^{”} is reached.

According to the equation “T_{D1,N,bright}=T_{D0,N} T_{D1,N,dark}, the duration T_{D1,N,bright} of the N-th first driving subfield in the first backlight driving mode D1 can be calculated.

Finally, the durations of the bright subfield and the dark subfield of the remaining first driving subfields in the first backlight driving mode D1 can be sequentially obtained using the above approach.

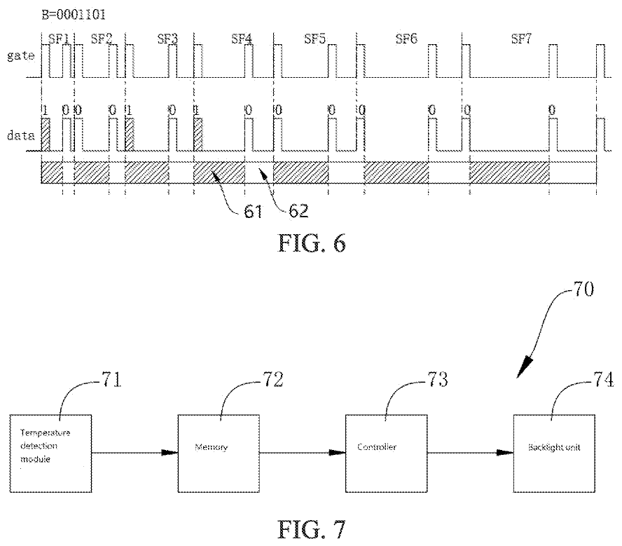

FIG. 6 is a diagram illustrating the waveforms of the gate voltage side and the data voltage side of the first backlight driving mode D1 provided in an embodiment of the present application when displaying the grayscale B=(0001101) B. As shown in FIG. 6, the ambient temperature T satisfies the condition “temp1≤T<temp2”. The backlight unit control method drives the backlight unit in the first backlight driving mode D1, each of the first driving subfields in the first backlight driving mode D1 includes a bright subfield 61 as well as a dark subfield 62. The first backlight driving mode D1 adjusts the durations of each of the first driving subfields of the backlight unit in a bright state at different periods, so that the display device has the same brightness performance under different ambient temperatures, thus reaching the goal of improving the stability of the backlight brightness.

Based on the same inventive concept, the present application also provides a display panel as shown in FIG. 7. FIG. 7 is a block diagram of the structure of the pixel compensation device of the display device of the present application. The display panel 70 includes a temperature detection module 71, a memory 72 for storing commands, a controller 73 for executing the commands to implement a method as described in any of the above embodiments, and a backlight unit 74.

Preferably, the memory 72 may comprise: read-only memory (ROM), random access memory (RAM), disk or CD-ROM, etc.

Based on the same inventive concept, the present application further provides a display device, which includes the display panel as described above.

To summarize, the backlight unit control method, the display panel, and the display device provided in the present application embodiments can control the brightness of the light emitted from the light-emitting units of the backlight unit based on non-equal molecular fields, and can make the display device have consistent brightness under different ambient temperatures by adjusting the duration of the bright subfield or dark subfield of each subfield of the backlight unit under different ambient temperatures in order to achieve the goal of improving the brightness stability of the display device. The purpose is to make the backlight brightness of the display device not shift with the increase of ambient temperature, and further prevent the problem of power overload of the display device. This further makes the backlight brightness of the display device not shift with the increase of the ambient temperature, thereby preventing the problem that the power of the display device exceeds the regulations.

In the above embodiments, the description of each embodiment has its own focus. As to the parts not described in detail in a particular embodiment, they can be realized by referencing the relevant descriptions of other embodiments.

The above embodiments of the present application provide a thorough introduction for the control method for the backlight unit, the display panel, and the display device, by introducing specific examples to illustrate the principles and implementation of the present application. It should be noted that the above embodiments of the present application is merely to help understand the technical solutions of the present application and its core ideas. One skilled in the art should understand that the technical solutions in the above-mentioned embodiments can still be modified or replaced by some equivalent approaches. These modifications or replacements, however, shall not make the merit of the technical solutions depart from those disclosed in the various embodiments of the present application. It is readily to understood to one skilled in the art that equivalent substitutions or changes may be made in accordance with the technical solutions and inventive concepts of the present application, and all such changes or substitutions shall fall within the claimed scope of the present application.

What is claimed is:

1. A control method for a backlight unit, comprising following steps:
S10: obtaining ambient temperature through a temperature detection module;
S20: comparing the ambient temperature with a first standardized temperature reference value; and
S30: determining a driving mode of light-emitting units included in the backlight unit based on a comparison result;
wherein when the ambient temperature is higher than or equal to the first standardized temperature reference value, the driving mode is determined as a first backlight driving mode, and the first backlight driving mode comprises first driving subfields, each of the first driving subfields consists of a bright subfield and a dark subfield.

2. The control method for the backlight unit of claim 1, wherein when the ambient temperature is less than the first standardized temperature reference value, the driving mode is an initial backlight driving mode with constant-voltage driving, wherein the initial backlight driving mode comprises initial driving subfields respectively corresponding to the first driving subfields, each of the initial driving subfields consists of a bright subfield or a dark subfield, and a sum of a duration of the bright subfield and a duration of the dark subfield of each of the first driving subfields is equal to that of a corresponding one of the initial driving subfields.

3. The control method for the backlight unit of claim 2, further comprising following steps between the steps S10 and S30:
S21: comparing the ambient temperature with a second standardized temperature reference value, wherein the second standardized temperature reference value is greater than the first standardized temperature reference value;
wherein when the ambient temperature is higher than or equal to the first standardized temperature reference value and less than the second standardized temperature reference value, the driving mode is the first backlight driving mode; and when the ambient temperature is higher than or equal to the second standardized temperature reference value, the driving mode is a second backlight driving mode;
wherein first driving subfields of the second backlight driving mode corresponds to the first driving subfields of the first backlight driving mode, and a time ratio of the bright subfield to the first driving subfields of the second backlight driving mode is less than a time ratio of the bright subfield to the first driving subfields of the first backlight driving mode.

4. The control method for the backlight unit of claim 2, further comprising following steps between the steps S10 and S30:
S21: comparing the ambient temperature with an (n+1)-th standardized temperature reference value, wherein the (n+1)-th standardized temperature reference value is greater than an n-th standardized temperature reference value;
wherein when the ambient temperature is higher than or equal to the n-th standardized temperature reference value and less than the (n+1)-th standardized temperature reference value, the driving mode is an n-th backlight driving mode, and a time ratio of the bright subfield of the n-th backlight driving mode to the first driving subfields is less than a time ratio of the bright subfield of an (n−1)-th backlight driving mode D(n−1) to the first driving subfields, wherein n is a positive integer greater than 2.

5. The control method for the backlight unit of claim 3, wherein a step of obtaining the duration of the bright subfield and the duration of the dark subfield within the first driving subfields in the first backlight driving mode or the second backlight driving mode comprises:
S201: driving the light-emitting units of the backlight unit according to a backlight driving mode of a previous level, wherein a maximum temperature in a temperature range corresponding to the backlight driving mode of the previous level is less than the ambient temperature;
S202: detecting whether a luminance value of the backlight unit is greater than that of the backlight unit driven in the backlight driving mode of the previous level in the corresponding temperature range; and
S203: adjusting the duration of the bright subfield or the duration of the dark subfield within the first driving subfields in the first backlight driving mode or the second backlight driving mode according to a detection result, so that the luminance value of the backlight unit is consistent with that of the backlight unit driven in the corresponding temperature range by the backlight driving mode of the previous level.

6. The control method for the backlight unit of claim 5, wherein the step S203 further comprises:
S2031: if the luminance value when the backlight unit displays 2^{N-1} grayscales is greater than an initial luminance value of the backlight unit driven in the backlight driving mode of the previous level in the corresponding temperature range, increase the duration of the dark subfield of an N-th first driving subfield until the backlight unit displays a luminance value at 2^{N-1} grayscale equal to the initial luminance value;
wherein if the luminance value of the backlight unit displaying 2^{N-1} grayscales is less than the initial luminance value, decrease the duration of the dark subfield of the N-th first driving subfield until the luminance value of the backlight unit displaying 2^{N-1} grayscales is equal to the initial luminance value, wherein N is a positive integer greater than or equal to 1.

7. The control method for the backlight unit of claim 1, wherein the first backlight driving mode is constructed by outputting the first driving subfields each having different durations in a predetermined order, and the first driving subfields are made by dividing a light-emitting process of a frame of each of the light-emitting units in the backlight unit through a dividing step, wherein the dividing step further comprises:
dividing the light-emitting process of the frame of each of the light-emitting units in the backlight unit into M number of the first driving subfields of the first driving subfields each having different durations, wherein a ratio of a duration of an i-th first driving subfield to a sum of durations of the M number of the first driving subfields is 2^{(i-1)-th}/2^{M}, the i-th first driving subfield corresponds to an (i−1)-th bit data, wherein i is an integer greater than or equal to 1 and less than or equal to M, and M is an integer greater than or equal to 2.

8. The control method for the backlight unit of claim 1, wherein each of the light-emitting units of the backlight unit is a sub-millimeter light-emitting diode.

9. A control method for a backlight unit, comprising following steps:
S10: obtaining ambient temperature through a temperature detection module;
S20: comparing the ambient temperature with a first standardized temperature reference value; and
S30: determining a driving mode of light-emitting units included in the backlight unit based on a comparison result;
wherein when the ambient temperature is higher than or equal to the first standardized temperature reference value, the driving mode is determined as a first backlight driving mode, and the first backlight driving mode comprises first driving subfields, each of the first driving subfields consists of a bright subfield and a dark subfield;
wherein a data voltage applied during a duration of the bright subfield is high potential, and a data voltage applied during a duration of the dark subfield is low potential.

10. The control method for the backlight unit of claim 9, wherein when the ambient temperature is less than the first standardized temperature reference value, the driving mode is an initial backlight driving mode with constant-voltage driving, wherein the initial backlight driving mode comprises initial driving subfields respectively corresponding to the first driving subfields, each of the initial driving subfields consists of a bright subfield or a dark subfield, and a sum of a duration of the bright subfield and a duration of the dark subfield of each of the first driving subfields is equal to that of a corresponding one of the initial driving subfields.

11. The control method for the backlight unit of claim 10, further comprising following steps between steps S10 and S30:
S21: comparing the ambient temperature with a second standardized temperature reference value, wherein the second standardized temperature reference value is greater than the first standardized temperature reference value;
wherein when the ambient temperature is higher than or equal to the first standardized temperature reference value and less than the second standardized temperature reference value, the driving mode is the first backlight driving mode; and when the ambient temperature is higher than or equal to the second standardized temperature reference value, the driving mode is the second backlight driving mode;
wherein first driving subfields of the second backlight driving mode correspond to the first driving subfields of the first backlight driving mode, and a time ratio of the bright subfield to the first driving subfield of the second backlight driving mode is less than a time ratio of the bright subfield to the first driving subfields of the first backlight driving mode.

12. The control method for the backlight unit of claim 10, further comprising following steps between the steps S10 and S30:
S21: comparing the ambient temperature with an (n+1)-th standardized temperature reference value, wherein the (n+1)-th standardized temperature reference value is greater than an n-th standardized temperature reference value;
wherein when the ambient temperature is higher than or equal to the n-th standardized temperature reference value and less than the (n+1)-th standardized temperature reference value, the driving mode is an n-th backlight driving mode, and a time ratio of the bright subfield of the n-th backlight driving mode to the first driving subfields is less than a time ratio of the bright subfield of an (n−1)-th backlight driving mode D(n−1) to the first driving subfields, wherein n is a positive integer greater than 2.

13. The control method for the backlight unit of claim 11, wherein a step of obtaining the duration of the bright subfield and the duration of the dark subfield within the first driving subfields in the first backlight driving mode or the second backlight driving mode comprises:
S201: driving the light-emitting units of the backlight unit according to a backlight driving mode of a previous level, wherein a maximum temperature in a temperature range corresponding to the backlight driving mode of the previous level is less than the ambient temperature;
S202: detecting whether a luminance value of the backlight unit is greater than that of the backlight unit driven in the backlight driving mode of the previous level in the corresponding temperature range; and
S203: adjusting the duration of the bright subfield or the duration of the dark subfield within the first driving subfields in the first backlight driving mode or the second backlight driving mode according to a detection result, so that the luminance value of the backlight unit is consistent with that of the backlight unit driven in the corresponding temperature range by the backlight driving mode of the previous level.

14. The control method for the backlight unit of claim 13, wherein the step S203 further comprises:
S2031: if the luminance value when the backlight unit displays 2^{N-1} grayscales is greater than an initial luminance value of the backlight unit driven in the backlight driving mode of the previous level in the corresponding temperature range, increase the duration of the dark subfield of an N-th first driving subfield until the backlight unit displays a luminance value at 2^{N-1} grayscale equal to the initial luminance value;
wherein if the luminance value of the backlight unit displaying 2^{N-1} grayscales is less than the initial luminance value, decrease the duration of the dark subfield of the N-th first driving subfield until the luminance value of the backlight unit displaying 2^{N-1} grayscales is equal to the initial luminance value, wherein N is a positive integer greater than or equal to 1.

15. The control method for the backlight unit of claim 9, wherein the first backlight driving mode is constructed by outputting the first driving subfields each having different durations in a predetermined order, and the first driving subfields are made by dividing a light-emitting process of a frame of each of the light-emitting units in the backlight unit through a dividing step, wherein the dividing step further comprises:
dividing the light-emitting process of the frame of each of the light-emitting units in the backlight unit into M number of the first driving subfields of the first driving subfields each having different durations, wherein a ratio of a duration of an i-th first driving subfield to a sum of durations of the M number of the first driving subfields is 2^{(i-1)-th}/2^{M}, the i-th first driving subfield corresponds to an (i−1)-th bit data, wherein i is an integer greater than or equal to 1 and less than or equal to M, and M is an integer greater than or equal to 2.

16. The control method for the backlight unit of claim 9, wherein each of the light-emitting units of the backlight unit is a sub-millimeter light-emitting diode.

17. A display panel, comprising:
a temperature detection module;
a memory for storing commands;
a controller for executing the commands to implement the control method of claim 1; and
a backlight unit.

18. The display panel of claim 17, wherein the memory comprises any one of a read-only memory, random access memory, disk, or optical disk.

19. The display panel of claim 17, wherein the backlight unit has a plurality of partitions, each of the partitions is provided with a light-emitting unit, and the light-emitting unit is a sub-millimeter light-emitting diode.

20. A display device, comprising the display panel of claim 19.
